(19) United States
(12) Patent Application Publication
(10) Pub. No.: US 2019/0017529 A1
(43) Pub. Date: Jan. 17, 2019

(54) INJECTOR FOR FILLING AN ANNULAR SPACE AROUND AN ANCHOR BOLT

(71) Applicant: Hilti Aktiengesellschaft, Schaan (LI)

(72) Inventors: Christoph HAKENHOLT, Feldkirch (AT); Bernhard SCHRANZ, Oberschuetzen (AT); Huu Toan NGUYEN, Eichberg (CH)

(73) Assignee: Hilti Aktiengesellschaft, Schaan (LI)

(21) Appl. No.: 16/069,142

(22) PCT Filed: Jan. 10, 2017
(86) PCT No.: PCT/EP2017/050364

§ 371 Date: Jul. 10, 2018

(30) Foreign Application Priority Data
Jan. 11, 2016 (EP) 16150747.0

(51) Int. Cl. F16B 13/14; B05C 17/005

(52) U.S. Cl. CPC F16B 13/146; B05C 17/00576

(57) ABSTRACT

An injector for filling an annular space formed around an anchor bolt includes a piston disk which has a through-opening for the anchor bolt and a quantity of curable compound mounted upstream of the piston disk, where the piston disk forms a piston for forcing at least some of the quantity of curable compound into the annular space.

### CROSS REFERENCE TO RELATED APPLICATIONS

This application claims the priority of International Application No. PCT/EP2017/050364, filed Jan. 10, 2017, and European Patent Document No. 16150747.0, filed Jan. 11, 2016, the disclosures of which are expressly incorporated by reference herein.

### BACKGROUND AND SUMMARY OF THE INVENTION

The invention relates to an injector for filling an annular space formed around an anchor bolt, a fastening arrangement with such an injector, a container with such an injector and a method for installing an anchor when using such an injector.

It is known to fill the annular space, which is formed around the anchor bolt of a mechanical anchor, particularly an expansion anchor, anchored in a hole, with a curable compound. The anchor can hereby he supported in a radial direction in the hole and also in the base plate, which can improve the load values, particularly under dynamic loads and/or cyclical loads in cracked concrete. According to DE 10204591 A1, the filling of the annular space occurs from the center of the hole, namely by a filling channel formed in the anchor bolt. In particular, the nozzle of an injector device is applied in a sealing manner to the filling channel and a compound is introduced into the filling channel. The introduced compound comes out through a transverse hole in the bolt.

WO 11116918 A2 discloses an injection washer, which has a filling orifice and a ventilation orifice. This injection washer is used in a method for the subsequent strengthening of a heavy-load anchor inserted in a hole. In the method, an injection device is connected to the filling orifice by means of an injection hose and a compound is carried from the injection device via the injection hose and via the injection washer into the hole.

An additional washer with a through-opening for introducing a curable compound into the hole is known from DE 10111470 A1. Washers with through-openings for introducing curable compounds into the hole are also offered under the name “Hilti Dynamic Set”. In the “Hilti Dynamic Set,” an injection device is also connected to the through-opening and a compound is carried from the injection device via the through-opening into the hole.

DE 102010037755 A1 describes a device for filling a slot through which an anchor bolt passes. According to DE 102010037755 A1, the device is not damped under the nut, but can be fitted over the anchor bolt and the nut, which is meant to allow the device to consist of plastic.

DE 102014106662 A1 describes an internal-threaded anchor and proposes, for the purpose of sealing an anchor hole against liquid penetration, a perforated disk-shaped sealing flange, which is applied in a liquid-tight manner to the end of the internal-threaded anchor, and which has a recess on a bottom side, which can be filled with a sealing compound through filling openings.

Additional anchors, in which expansion elements are used in combination with curable compounds, are known from DE 10360156 A1, DE 102006000475 A1, DE 10216897 A1, DE 10060510 A1, WO 9857035 A1, U.S. Pat. No. 5,919,006 A, U.S. Pat. No. 5,636,945 A, U.S. Pat. No. 5,042,961 A, U.S. Pat. No. 5,064,312 A, U.S. Pat. No. 4,601,614 A, U.S. Pat. No. 4,516,883 A, U.S. Pat. No. 4,556,344 A, U.S. Pat. No. 3,702,060A, U.S. Pat. No. 3,695,045 A, U.S. Pat. No. 3,204,416 A, U.S. Pat. No. 3,326,004 A, U.S. Pat. No. 2,952,129 A, U.S. Pat. No. 3,379,019 A, U.S. Pat. No. 2,667,037 A and DE 102011055878 A1.

DE 19749571 A1 describes an anchor for attaching dynamically cross-loaded objects to an attachment base, with a chemically anchored anchor bolt, which has on its rear section a flange sleeve enclosing the anchor bolt, which after installing the anchor penetrates into the bore hole region that adjoins the borehole opening and that has had its diameter increased, and whose stop flange abuts the surface of the attachment base, wherein between the stop flange and the front end of the flange sleeve, there is provided an annular space that encloses the flange sleeve and can be filled with mortar.

DE 102009006207 A1 and US 20090180831 A1 teach one to fill annular spaces around anchor bolts with solids.

The object of the invention is to provide an injector that is particularly simple and quick to operate and also inexpensive and reliable for filling an annular space formed around an anchor bolt, a fastening arrangement with such an injector, a container with such an injector and a method for installing an anchor when using such an injector.

An injector according to the invention for filling an annular space formed around an anchor bolt is equipped with a piston disk, which has a through-opening for the anchor bolt, and a quantity of a curable compound upstream from the piston disk, wherein the piston disk forms a piston for squeezing at least part of the quantity of the curable compound, particularly out of the injector, into the annular space.

A basic concept of the invention can be seen by combining the curable compound that is to be pressed out with a piston disk, through which the anchor bolt of the anchor passes. The invention recognized that in conventional fastening arrangements using an anchor, a washer is often provided through which the anchor bolt of the anchor passes, and which is pressed to the base plate to be attached to the substrate during installation of the anchor. The invention now proposes to arrange a quantity of a curable compound between this washer and the base plate, or between this washer and the substrate under the base plate. In this configuration, the washer acts as a piston disk, which, when one presses the washer against the base plate or directly against the substrate while installing the anchor, presses out at least a portion of the quantity of the curable compound in the annular space around the anchor bolt.

When using an injector according to the invention, the curable compound is thus pressed out automatically into the annular space around the anchor bolt in the course of installing the anchor. The injector according to the invention is simply fitted on to the anchor and the anchor nut is tightened as usual and the system is then ready. Thus, no additional work step and no additional tool, such as a separate injection device, which would have to he connected in a cumbersome manner, are required. In this way, a particularly simple, quick, safe, reliable and also cost-effective filling process is provided. Since no supply line is required according to the invention, the quantity of waste can also he kept particularly low, Since according to the invention one is working with a fluid, curable compound, which cures only after a certain time delay, particularly in the annular space, the requirements in terms of aligning the components are comparatively low in contrast to systems in which solids are placed in the annular space.

The piston disk according to the invention forms a piston for squeezing at least a portion of the quantity of the curable compound out of the injector into the annular space and for pressing at least a portion of the quantity of the curable compound out of the injector into the annular space. Such an annular space often remains in the substrate and also in the base plate around the anchor bolt, since the anchor bolt often has a smaller diameter than the hole in the base plate and substrate to ensure that the anchor bolt is reliably inserted into the hole.

In regard to an injector according to the invention, a curable compound can he pressed out of the injector by an axial pressing of the piston disk against a surface, particularly by an axial pressing of the piston disk against the surface of the base plate, but also against the surface of the substrate, wherein these two surfaces enclose the hole in which the anchor bolt is inserted in an annular fashion. According to the invention, there is a piston space between the piston disk on the one hand and the substrate and/or the base plate on the other, the space having its volume decreased by bringing the piston disk closer to the substrate and/or the base plate when pressing out the curable mass. When operating the injector, the piston disk is brought closer axially to the substrate and/or to the base plate, i.e., the piston disk is moved in particular at least almost parallel to the through-opening in the piston disk and/or in particular at least almost parallel to the longitudinal axis of the anchor bolt.

To the extent that reference here is made to a radial, axial and/or circumferential direction, this may apply particularly to the longitudinal axis of the anchor bolt and/or the longitudinal axis of the injector, wherein the latter may be defined particularly by the through-opening in the piston disk.

The curable mass may also be referred to as a fluid, curable filler. The compound may involve for example a multi-component synthetic resin mortar on the basis of polyester or epoxy resin, which is activated by mixing the components. Particularly in this case, the curable compound may be present in the injector, particular in its reservoir, in the form of separate preliminary products, which are mixed When pressed out. The compound is preferably an adhesive.

The anchor, to whose anchor bolt the injector according to the invention is arranged, can be an expansion anchor for example, preferably a bolt-type expansion anchor. An expansion anchor can have in particular a wedge gear, which transforms a pulling movement of the anchor bolt relative to the substrate into a radial movement of an expansion element arranged on the anchor bolt, particularly an expansion sleeve arranged on the anchor bolt, relative to the anchor bolt and thus anchors the anchor to the substrate. The anchor may also be a chemical anchor, which is anchored in the substrate by means of an additional curable compound, wherein this additional curable compound can be chemically identical to or different than the curable compound of the injector.

Particularly when mixing elements are arranged on the piston disk, this can also be referred to as a mixing washer. The annular space around the anchor bolt in particular can be an annular gap.

The piston disk can consist preferably of a metal material. For example, it can be manufactured in a stamping process, which may be advantageous with regard to costs.

Depending on the design of the injector, a more or less large residual volume of the quantity of the curable compound will often remain in. the injector, i.e., the piston disk generally squeezes out only a part, albeit often a large part, of the quantity of the curable compound into the annular space.

It is particularly preferable that the quantity of the curable compound is arranged in a reservoir. With this, the curable compound can be protected in a particularly simple and reliable manner against environmental factors, and the manufacture of the injector can be further simplified. For example, the reservoir can be a pouch, particularly a foil pouch. The reservoir can in particular have a through-opening aligning with the through-opening of the piston disk in order to ensure that the anchor bolt passes through the injector without affecting the curable compound. The reservoir can also be omitted particularly when the curable compound has a very high viscosity such that the compound is sufficiently dimensionally stable due to its viscosity alone, or if the injector fully encloses the quantity of the curable compound.

Another preferred design of the invention consists of the injector having a sealing washer, where the quantity of the curable compound is arranged at least partially, in particular fully between, in particular axially between the piston disk and the sealing washer. Such a sealing washer can channel the flow of the curable compound when being pressed out of the injector and can thus ensure in a particularly simple manner that the curable compound is pressed into the annular space in a particularly reliable manner and especially that it is not simply squeezed away. In addition, when using a sealing washer, the quantity of the curable compound can be positioned in a particularly simple manner, since the quantity of the curable compound can be enclosed between the piston disk and the sealing washer. Preferably, the quantity of the curable compound, particularly the reservoir, can be connected to the sealing washer, which can be advantageous from a manufacturing perspective and can simplify the positioning of the quantity of the curable compound. The sealing washer can also form mixing channels, which can further improve the mixing of the curable compound. It may he provided that the sealing disk is destroyed during the process in which the curable compound is pressed out. For example, the sealing washer can consist of plastic, which may he advantageous in terms of manufacturing costs. For example, the sealing washer may be produced in an injection-molding procedure. Preferably, the sealing washer may have on its side facing away from the piston disk a sealing lip for a particularly good sealing effect with the surface surrounding the hole.

It is particularly practical that the injector has at least one sealing sleeve, wherein the quantity of the curable compound is arranged at least partially within the sealing sleeve. Such a sealing sleeve, which can radially border a piston chamber of the piston disk, can counteract an undesired radial discharge of the curable compound in a particularly simple and reliable manner.

For practical purposes, the sealing sleeve is arranged in an axially fixed manner at one of the two elements, namely the piston disk or the sealing washer, and preferably integrally designed with it, and the respective other element, namely the sealing washing or piston disk, is axially displaceable in the sealing sleeve.

In this way, in a first embodiment, the piston disk can be arranged in a displaceable, preferably axially displaceable, manner within the sealing sleeve. In particular, the sealing sleeve can be attached to the sealing washer and preferably be constructed integrally with the sealing sleeve. The sealing sleeve consists preferably of a plastic material, as a result of which a particularly good sealing function can be achieved in a particularly simple manner.

In a second embodiment, the sealing sleeve can be attached to the piston disk, preferably be attached at least axially, and in particular be constructed integrally with the piston disk. In this design, the sealing washer can be arranged in an axially displaceable manner within the sealing sleeve.

Two sealing sleeves may also be provided, a first one on the piston disk and a second one on the sealing washer. The two sealing washers may run into one another in a telescopic mariner.

It is furthermore practical that the injector has mixing elements, which project toward the quantity of the curable compound, particularly toward the reservoir. Such mixing elements, which can be designed in a pin-type manner for example, can define and/or border mixing channels, and thus improve the mixing of the curable compound when pressed out of the injector in a particularly simple manner, so that reliability can be further improved. The mixing elements can be arranged on the piston disk and/or on the sealing washer, if the latter is present.

Preferably, the injector has recesses to accommodate at least a part of the mixing elements when squeezing out at least part of the quantity of the curable compound using the piston disk. These recesses are preferably located axially offset on the respective other of the two elements, namely the piston disk or the sealing washer, to which the mixing elements are arranged, so that the mixing elements can engage in a finger-like manner into the recesses When the piston disk comes closer to the sealing washer when pressing out the curable compound. Given good mixing action of the curable compound, this allows for a particularly complete pressing-out of the curable compound.

Another preferred development of the invention is that the piston disk is designed on its side facing the quantity of the curable compound, i.e., preferably on its side facing the sealing washer, in a concave manner at least regionally, and/or that the sealing washer is designed on its side facing the quantity of the curable compound, i.e., preferably on its side facing the piston disk, in a concave manner at least regionally. Through the concave design of the respective disks/washers, a radial discharge of the curable compound can be counteracted in a particularly simple and effective manner.

The invention also relates to a fastening arrangement having an injector according to the invention and having an anchor with an anchor bolt, which passes through the through-opening of the injector. In this operationally ready configuration, the injector and particularly its piston disk arc fitted on the anchor bolt of the anchor. In particular, the anchor can have an anchor nut arranged on the anchor bolt Which forms an axial bearing for the injector and thus fixes the injector in a direction axial to the anchor holt. When tightening this anchor nut, the injector .is pressed to the base plate or the substrate and the curable compound is hereby mixed and simultaneously pressed into the annular space. However, the anchor nut can contact the piston directly or also indirectly.

The invention also relates to a container containing an injector according to the invention and an anchor. A container can in a customary manner refer particularly to the whole, which comprises the packaging and the packaged goods.

The invention further relates to a method for installing an anchor with an anchor bolt, wherein in the method, the anchor bolt of the anchor is arranged in a hole and by means of an injector according to the invention, a curable compound, particularly out of the injector, is inserted in an annular space surrounding the anchor bolt in the hole. Accordingly, the injector is utilized as intended.

It is particularly preferred that the piston disk of the injector is pressed, by tightening an anchor nut arranged on the anchor bolt, against a surface, particularly a surface of the substrate, in which the annular space is formed at least regionally, or particularly on a surface of a base plate, in which the annular space is formed at least regionally, and the curable compound is hereby squeezed by the piston disk and introduced into the annular space.

The injector according to the invention can also be used as a setting control of the anchor. For example, the sealing sleeve arranged on the sealing washer can be dimensioned in such a manner that, after correct installation of the anchor with the injector, it protrudes axially on the exterior side of the injector beyond the piston disk. If the interior side of the sealing sleeve is color-coded, for example in green, the user is given visual confirmation that the system was correctly installed.

On a regular basis, the injector according to the invention will be positioned between the base plate and the anchor nut; however, the injector could basically also he arranged between the substrate and the base plate.

Features that are explained in connection with the injector according to the invention may also be used with the fastening arrangement according to the invention, the container according to the invention and/or the method according to the invention, and reciprocally features exemplified in connection with the fastening arrangement according to the invention, the container according to the invention and/or the method according to the invention can also be used on the injector according to the invention.

The invention is explained in greater detail below using preferred embodiments, which are depicted schematically in the attached drawings, wherein individual features of the embodiments depicted below can essentially be designed within the scope of the invention either individually or in any combination.

### BRIEF DESCRIPTION OF THE DRAWINGS

FIG. 1: A longitudinal sectional view of a fastening arrangement according to the invention with an injector according to the invention and an anchor, wherein the anchor bolt of the anchor is arranged in a hole, which extends through a base plate into a substrate;

FIG. 2: A view from below of the piston disk of the injector from FIG. 1;

FIG. 3: A magnified view of the injector from FIG. 1 in a longitudinal sectional. view, i.e. according to section A-A of FIG. 2;

FIG. 4: A view from below of the piston disk of the injector according to a second embodiment;

FIG. 5: The injector of the second embodiment in a longitudinal sectional view, i.e., according to section A-A of FIG. 4;

FIG. 6: A transparent view from above of an injector according to a third embodiment;

FIG. 7: The injector of the third embodiment in a longitudinal sectional view, i.e., according to section A-A of FIG. 6;

FIG. 8: The piston disk of the injector of the third embodiment from below;

FIG. 9: The piston disk of the injector of the third embodiment in a longitudinal sectional view. i.e., according to section A-A of FIG. 8;

FIG. 10: The sealing washer of the injector of the third embodiment from above;

FIG. 11: The sealing washer of the injector of the third embodiment in a longitudinal sectional view, i.e., according to section A-A of FIG. 10;

FIG. 12: A view from above of an injector according to a fourth embodiment;

FIG. 13: The injector of the fourth embodiment in a longitudinal sectional view, i.e., according to section A-A of FIG. 12;

FIG. 14: The piston disk of the injector of the fourth embodiment from below;

FIG. 15: The piston disk of the injector of the fourth embodiment in a longitudinal sectional view, i.e., according to section A-A of FIG. 14;

FIG. 16: The sealing disk of the injector of the fourth embodiment from above;

FIG. 17: The sealing disk of the injector of the fourth embodiment in a longitudinal sectional view, i.e., according to section A-A of FIG. 16; and

FIG. 18: A view corresponding to FIG. 1 with additional arrows to explain the method according to the invention.

### DETAILED DESCRIPTION OF THE DRAWINGS

Elements essentially acting the same are labeled with the same reference signs in the various embodiments.

A first embodiment of a fastening arrangement is shown in FIGS. 1 to 3. The fastening arrangement has an anchor 1 with an anchor bolt 10 as well as an injector 3

In the front region of anchor 1, anchor 1 has an anchoring zone 12, in which anchor boll 10 can be anchored to wall 98 of a hole 99. In FIG. 1, anchor 1 is illustratively depicted as a bolt-type expansion anchor. As such, anchor 1 has in anchoring zone 12 an expansion sleeve and an expansion cone formed on anchor bolt 10 for radially pressing the expansion sleeve against wall 98 of hole 99, given a tension load in anchor bolt 10. However, the design of anchor 1 as a bolt-type expansion anchor should be regarded as merely illustrative, and anchor 1 can also have anchoring zones 12 that act in other ways. Preferably, anchoring zone 12 is a mechanical anchoring zone, in other words an anchoring zone which effects at least primarily a form-locking or friction-locking anchoring. Basically however, anchoring zone 12 could also be a chemical anchoring zone, in other words an anchoring zone which effects an at least primarily material-bonded anchoring.

In the rear region of anchor 1, anchor bolt 10 is equipped with an exterior thread 18. Screwed on to the exterior thread is an anchor nut 8 with an interior thread corresponding to exterior thread 18.

The fastening arrangement also has an injector 3 explained in detail below, wherein anchor bolt 10 of anchor 1 passes through injector 3.

FIG. 1 depicts the fastening arrangement when installing anchor 1. Accordingly, the front end of anchor bolt 10 of anchor 1 is guided into a hole 99 in a base plate 6 and a substrate 5, for example a concrete substrate, adjoining base plate 6. Injector 3 surrounding anchor bolt 10 is located between anchor nut 8 and base plate 6 abutting substrate 5, and thus also between anchor nut 8 and substrate 5. In hole 99, an annular space 97 is formed around anchor bolt 10 which extends from base plate 6 into substrate 5.

Injector 3 of the embodiment of FIGS. 1 to 3 has a metallic piston disk 31 with a through-opening 41, through which anchor bolt 10 passes. Upstream from piston disk 31 is a reservoir 33, for example a foil pouch, which contains a quantity 30 of a curable compound, Reservoir 33 is designed in a ring-shaped manner and surrounds anchor bolt 10. Upstream from reservoir 33 is a sealing washer 51, which also has a through-opening 61, through which anchor bolt 10 passes. Reservoir 33 is thus located between piston disk 31 and sealing washer 51, wherein piston disk 31 of anchor nut 8 and sealing washer 51 faces substrate 5 and base plate 6. Sealing washer 51 has on its exterior side facing away from piston disk 31, i.e., on its exterior side facing away from quantity 30 of the curable compound, a sealing lip 55.

In FIG. 18, the operating mode of injector 3 of the embodiment of FIGS. 1 to 3 is indicated in a method according to the invention by means of arrows. As FIG. 18 shows, anchor nut 8 is tightened using exterior thread 18 of anchor bolt 10. Since anchor bolt 10 anchors itself at its anchoring zone 12 in substrate 5, anchor nut 8 hereby comes closer to substrate 5. Since anchor nut 8 is cross-sectionally larger than through-opening 41 in piston disk 31, piston disk 31 is hereby carried along by anchor nut 8. Consequently, injector 3 is pressed together between anchor nut 8 on the one hand and substrate 5 and possibly base plate 6, which form a counter-bearing for injector 3, on the other, and piston disk 31 is pressed against sealing washer 51. Reservoir 33, containing quantity 30 of the curable compound, is hereby pressed out, and the curable compound goes out of injector 3 into annular space 97 around anchor bolt 10, where the compound ultimately cures, i.e. becomes rigid, in other words, the curable compound between piston disk 31 acting as a piston and base plate 6 is squeezed out. of injector 3 into annular space 97 around anchor bolt 10.

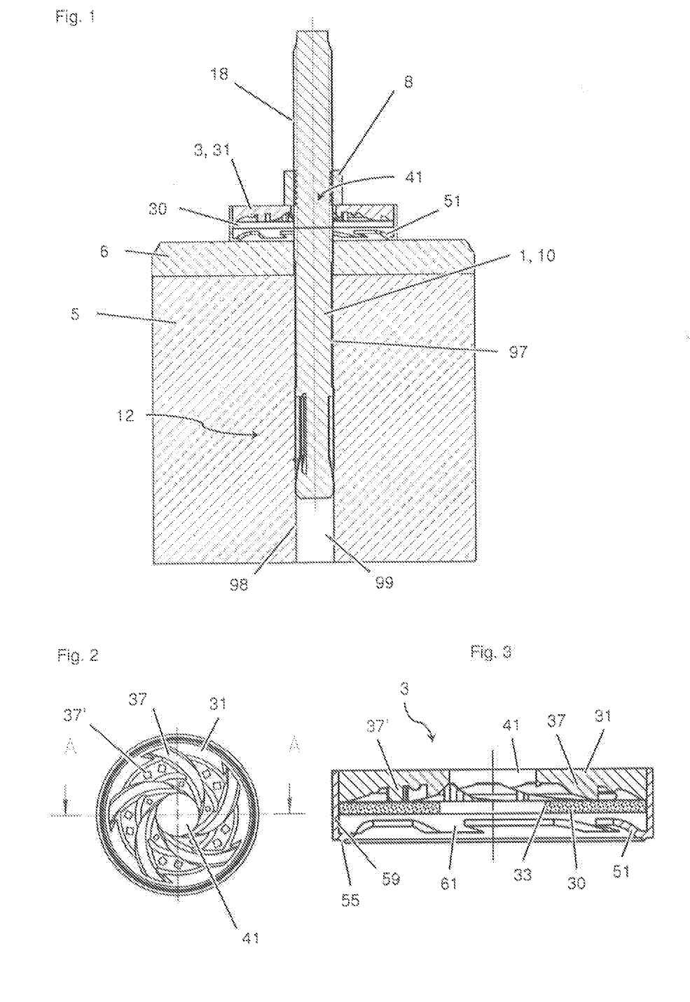

As particularly FIGS. 2 and 3 show, piston disk 31 of injector 3 of the embodiment of FIGS. 1 to 3 has mixing elements 37 and 37′, which project toward quantity 30 of the curable compound. particularly toward reservoir 33, from piston disk 31. Mixing elements 37 arc pin-shaped and mixing elements 37′ are crescent-shaped. Mixing elements 37 and 37′ together form a complex geometry, which ensures good mixing of the curable compound both in the pure translational motion of piston disk 31 and sealing washer 51 toward each other as well as in a purely relative rotation of piston disk 31 and sealing disk 51 toward each other without a translational motion.

Through-opening 41, provided for passing through anchor bolt 10, in piston disk 31 can he designed in a circular manner, for example. As shown in FIG. 3 in particular, through-opening 61 of sealing washer 51 conversely has a cross-sectional shape differing from a circular form. so that mixing lobes for the curable compound are formed at through-opening 61 of sealing washer 51.

As FIGS. 1 and 3 show in particular, injector 3 of the embodiment of FIGS. 1 to 3 has a sealing sleeve 59, in which piston disk 31 is displaceably arranged, and which seals off injector 3, particularly its reservoir 33, in a radial direction. In the embodiment of FIGS. 1 to 3, the preferably cylindrical sealing sleeve 59 is arranged securely on sealing washer 51 and in particular designed integrally with sealing washer 51. Basically however, sealing sleeve 59 and sealing washer 51 can also be separate parts. For a particularly good sealing effect, sealing washer 51 and/or sealing sleeve 59 in particular can consist of a plastic material.

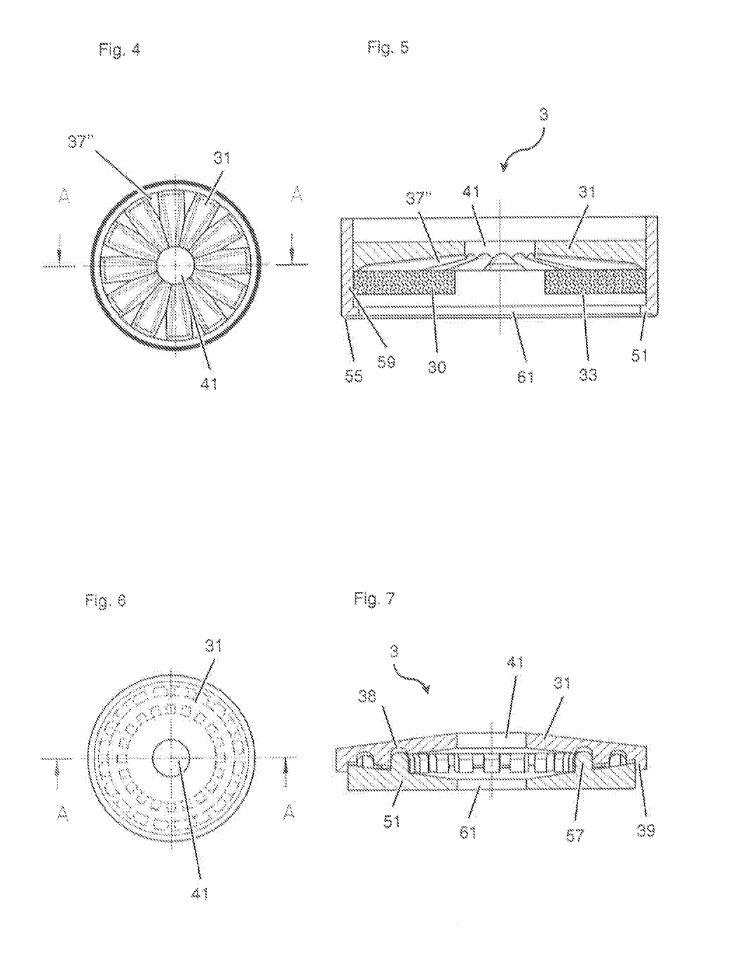

FIGS. 4 and 5 depict an alternative embodiment of an injector 3. Injector 3 of FIGS. 4 and 5 can be used in the fastening arrangement of FIGS. 1 to 3 and in the method shown in FIG. 18 instead of the injector 3 respectively shown there.

Injector 3 of the embodiment of FIGS. 4 and 5 implements a series of features of injector 3 of the embodiment of FIGS. 1 to 3 in a similar manner, so that the aforementioned description can be applied similarly to that extent.

However, in particular, injector 3 of the embodiment of FIGS. 4 and 5 differs from injector 3 of the embodiment of FIGS. 1 to 3 by the design of mixing elements 37″ at piston disk 31: In the embodiment of FIGS. 4 and 5, piston disk 31 has wedge-shaped mixing elements 37″, which broaden radially outward. In the longitudinal sectional view (FIG. 5), piston disk 31 is constructed concavely on its side facing quantity 30 of the curable compound.

Furthermore, injector 3 of the embodiment of FIGS. 4 and 5 differs from injector 3 of the embodiment of FIGS. 1 to 3 by the design of through-opening 61 in sealing washer 51: Through-opening 61 in sealing washer 51 of the embodiment of FIGS. 4 and 5 is designed essentially circularly in its cross-section.

Sealing washer 51 of the embodiment of FIGS. 4 and 5 once again has a sealing sleeve 59, which prevents the curable compound from being pressed away radially and which instead ensures that the curable compound is primarily pressed into the center of injector 3 and. thus into hole 99 and into annular space 97. Sealing washer 51 of the embodiment of FIGS. 4 and 5 once again also has on its exterior side facing away from piston disk 31, i.e., on its exterior side facing away from quantity 30 of the curable compound, a sealing lip 55, which abuts the surface of base plate 6 when the injector is in operation.

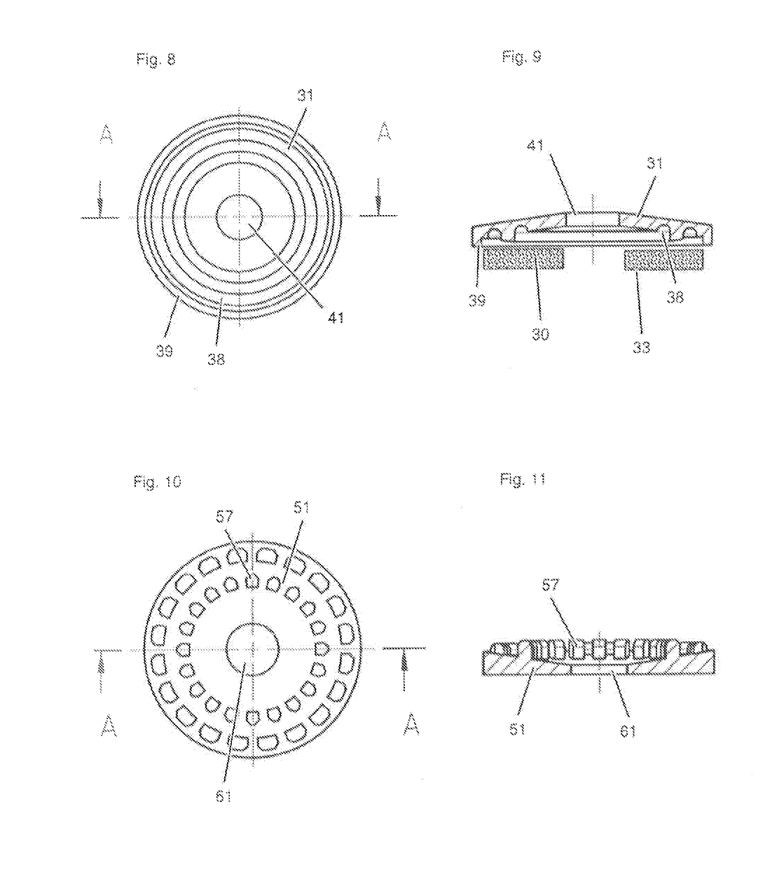

FIGS. 6 to 11 show a third alternative embodiment of an injector 3. Injector 3 of FIGS. 6 to 11 can be used in the fastening arrangement of FIGS. 1 to 3 and in the method shown in FIG. 18 instead of the injector 3 respectively shown there.

Injector 3 of FIGS. 6 to 11 once again has a piston disk 31 with a through-opening 41 for anchor bolt 10 as well as a sealing washer 51 with a through-opening 61 for anchor bolt 10, wherein the two through-openings 41 and 61 are aligned with each other, and wherein between piston disk 31 and sealing washer 51, there is arranged a reservoir 33 with a quantity 30 of a curable compound. For the sake of simplicity, reservoir 33 is depicted with quantity 30 of the curable compound only in FIG. 9.

Regarding the embodiment of FIGS. 6 to 11, both piston disk 31 as well as sealing washer 51 are formed from a metal material. Once again, pin-shaped mixing elements 57 are provided, wherein these are arranged on sealing washer 51 in the embodiment of FIGS. 6 to 11. Piston disk 31 has recesses 38, ring-shaped here for illustrative purposes, for accommodating mixing elements 57. Additionally or alternatively, recesses corresponding to the mixing elements on piston disk 31 can also be arranged on the piston disk 31 mixing elements and preferably on sealing washer 51.

Regarding the embodiment of FIGS. 6 to 11, a sealing sleeve 39 is provided once again, which seals injector 3 in a radial direction. However, in contrast to the two previously described embodiments, sealing sleeve 39 according to the embodiment of FIGS. 6 to 11 is arranged in an axially fixed manner to piston disk 31 and preferably constructed integrally with piston disk 31. Sealing disk 51 of the embodiment of FIGS. 6 to 11 is accordingly arranged in an axially displaceable manner inside sealing sleeve 39.

Regarding the embodiment of FIGS. 6 to 11, both piston disk 31 as well as sealing washer 51 are designed concave on the interior sides respectively facing quantity 30 of the curable compound.

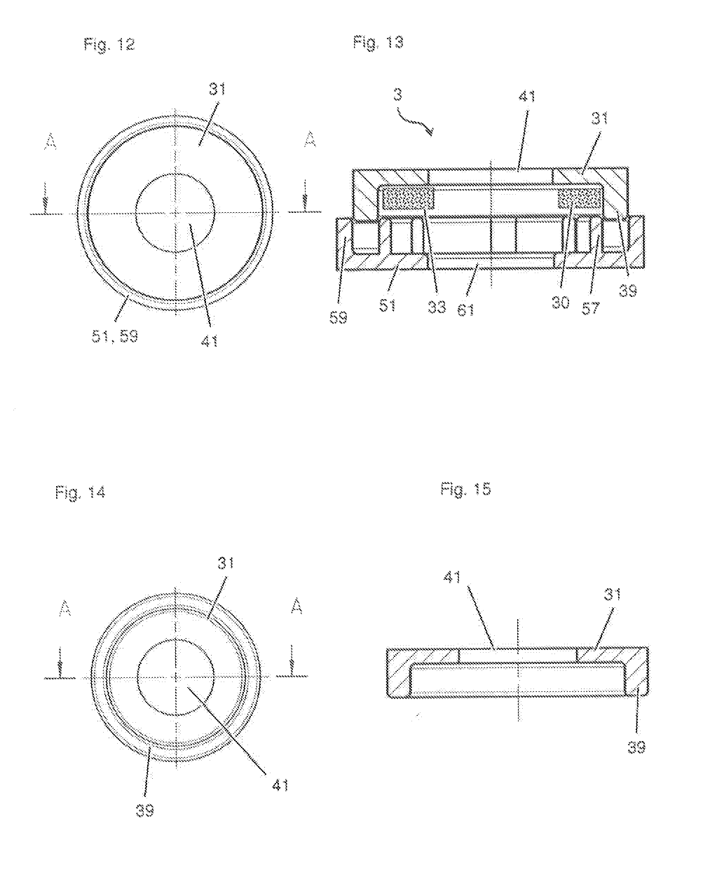

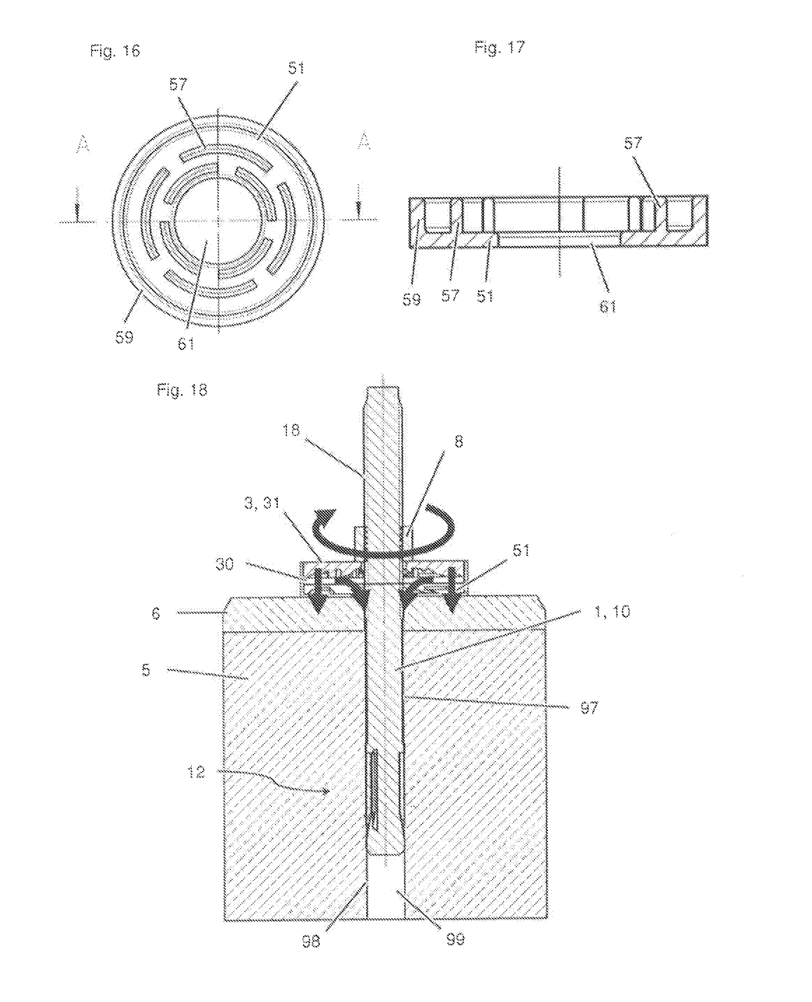

FIGS. 12 to 17 show a fourth alternative embodiment of an injector 3. Injector 3 of FIGS. 12 to 17 can be used in the fastening arrangement of FIGS. 1 to 3 and the method. shown in FIG. 18 instead of the injector 3 respectively shown there.

Injector 3 of FIGS. 12 to 17 once again has a piston disk 31 with a through-opening 41 for anchor bolt 10 as well as a sealing disk 51 with a through-opening 61 for anchor bolt 10, wherein the two through-openings 41 and 61 align with each other, and wherein between piston disk 31 and sealing washer 51, a reservoir 33 with a quantity 30 of a curable compound is arranged. For the sake of simplicity, reservoir 33 is depicted with quantity 30 of the curable compound only in FIG. 13.

Regarding the embodiment of FIGS. 12 to 17, both piston disk 31 as well as sealing washer 51 are formed of a metal material. Once again, mixing elements 57 are provided on sealing washer 51, wherein these mixing elements 57 are designed having a circular arc shape in the embodiment of FIGS. 12 to 17.

In the embodiment of FIGS. 12 to 17, two sealing sleeves 39 and 59 are provided, which seal off injector 3 in a radial direction, namely a first sealing sleeve 39, which is arranged in an axially secure manner to piston disk 31 and preferably constructed integrally with piston disk 31, and a second sealing sleeve 59, which is arranged in an axially secure manner to piston disk 51 and preferably constructed integrally with piston disk 51. Sealing sleeve 39 is thereby designed with a smaller diameter than sealing sleeve 59, and piston disk 31 with sealing sleeve 39 is arranged in an axially displaceable manner inside sealing sleeve 59 of sealing washer 51.

1.-12. (canceled)

13. An injector for filling an annular space formed around an anchor bolt, comprising:
a piston disk, wherein the piston disk has a through-opening and wherein the anchor bolt is passable through the through-opening; and
a quantity of a curable compound upstream from the piston disk, wherein the piston disk forms a piston for squeezing at least a portion of the quantity of the curable compound into the annular space.

14. The injector according to claim 13, wherein the quantity of the curable compound is disposed in a reservoir.

15. The injector according to claim 13 further comprising sealing washer, wherein the quantity of the curable compound is disposed at least partially between the piston disk and the sealing washer.

16. The injector according to claim 13 further comprising a sealing sleeve, wherein the quantity of the curable compound is disposed at least partially inside the sealing sleeve.

17. The injector according to claim 16, wherein the piston disk is disposed in an axially displaceable manner inside the sealing sleeve or wherein the sealing sleeve is attached to the piston disk.

18. The injector according to claim 13 further comprising mixing elements which protrude toward the quantity of the curable compound.

19. The injector according to claim 18 further comprising recesses for accommodating at least a portion of the mixing elements when squeezing at least a portion of the quantity of the curable compound by the piston disk.

20. The injector according to claim 13, wherein the piston disk is concave at least regionally on a side facing toward the quantity of the curable compound.

21. A fastening arrangement, comprising:
the injector according to claim 13; and
an anchor with an anchor bolt, wherein the anchor bolt passes through the through-opening of the injector.

22. A container comprising the injector according to claim 13 and an anchor.

23. A method for installing an anchor having an anchor bolt, comprising the steps of:
disposing the anchor bolt of the anchor in a hole; and
introducing the curable compound into an annular space surrounding the anchor bolt in the hole by the injector according to claim 13.

24. The method according to claim 23, wherein the piston disk of the injector is pressed to a surface by tightening an anchor nut disposed on the anchor bolt and wherein the curable compound is squeezed using the piston disk.
